(19) United States
(12) Patent Application Publication
(10) Pub. No.: US 2026/0180650 A1
(43) Pub. Date: Jun. 25, 2026

(54) ON REPORTING APPLICABLE FUNCTIONALITIES FOR WTRU-SIDE AIML MODELS

(71) Applicant: InterDigital Patent Holdings, Inc., Wilmington, DE (US)

(72) Inventors: Nazli Khan Beigi, Longueuil (CA); Young Woo Kwak, Woodbury, NY (US); Moon IL Lee, Melville, NY (US); Oumer Teyeb, Montreal (CA); Dylan Watts, Montreal (CA); Patrick Tooher, Montreal (CA); Yugeswar Deenoo Narayanan Thangaraj, Chalfont, PA (US); Haseeb Ur Rehman, Winnipeg (CA)

(73) Assignee: InterDigital Patent Holdings, Inc., Wilmington, DE (US)

(21) Appl. No.: 18/990,454

(22) Filed: Dec. 20, 2024

(51) Int. Cl. H04B 7/06; H04B 17/391

(52) U.S. Cl. CPC H04B 7/0626; H04B 7/06952; H04B 17/3913

(57) ABSTRACT

A wireless transmit/receive unit (WTRU) may receive a set of channel state information (CSI) report configurations that may be associated with one or more functionalities associated with an AIML model. The WTRU may determine, based on one or more conditions, that a first functionality of the one or more functionalities is non-applicable. The WTRU may transmit a first indication (e.g., via MAC-CE) that the first functionality is non-applicable to the network. The WTRU may start a timer upon determining that the first functionality is non-applicable. The WTRU may transmit one or more CSI reports that include predicted (e.g., inaccurate). The WTRU may determine that the timer has expired, and may transmit a second indication (e.g., via RRC) that the functionality is non-applicable. The WTRU may receive an indication to fallback to non-AIML operation and/or an indication to use an applicable second functionality of the one or more functionalities.

### BACKGROUND

In wireless transmit/receive unit (WTRU)-sided AIML models, inference may be performed at the WTRU. As such, the WTRU decides the applicable functionalities based on NW-side additional conditions (e.g., if provided), WTRU-side additional conditions (e.g., internally known by the WTRU), and/or model availability in device. As the WTRU is using an AIML model corresponding to a functionality, the WTRU may realize that the AIML model is not applicable anymore. A procedure to indicate the non-applicability may be desired. For example, in WTRU-side AIML models, the non-applicability of a functionality may be indicated based on a CSI Report framework.

### SUMMARY

Systems, methods, and instrumentalities for reporting applicable functionalities for WTRU-side AIML models are disclosed herein. One or more of the methods disclosed herein may be implemented by a wireless transmit/receive unit (WTRU) and/or a UE, for example via a processor thereof.

A wireless transmit/receive unit (WTRU) (e.g., a processor thereof) may receive, from a network, a set of channel state information (CSI) report configurations that may be associated with one or more functionalities associated with an AIML model. The WTRU may determine, based on one or more conditions, that a first functionality of the one or more functionalities is non-applicable. For example, the conditions may include a change in the speed of the WTRU, one or more channels, and/or a loss of service. The WTRU may transmit a first indication (e.g., via MAC-CE) that the first functionality is non-applicable to the network. The WTRU may start a timer upon determining that the first functionality is non-applicable. The WTRU may transmit one or more CSI reports that include predicted (e.g., inaccurate) values to the network.

The WTRU may determine a priority level (e.g., a maximum value indicating a lowest priority level) associated with the one or more CSI reports based on the received set of CSI report configurations, and may include the priority level in the first indication that the first functionality is non-applicable. The WTRU may determine that the timer has expired, and may transmit a second indication (e.g., via RRC) that the functionality is non-applicable to the network. The WTRU may receive, from the network, an indication to fallback to non-AIML operation and/or an indication to use an applicable second functionality of the one or more functionalities. The WTRU may use the second functionality to predict one or more best beams and report, to the network, the predicted one or more best beams using a CSI report configuration of the received set of CSI report configurations.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of applicable functionality reporting for beam management WTRU-sided model.

FIG. 3 shows an example of indicating codepoints via CRI signaling.

FIG. 4 illustrates another example of indicating codepoints via CRI signaling.

### DETAILED DESCRIPTION

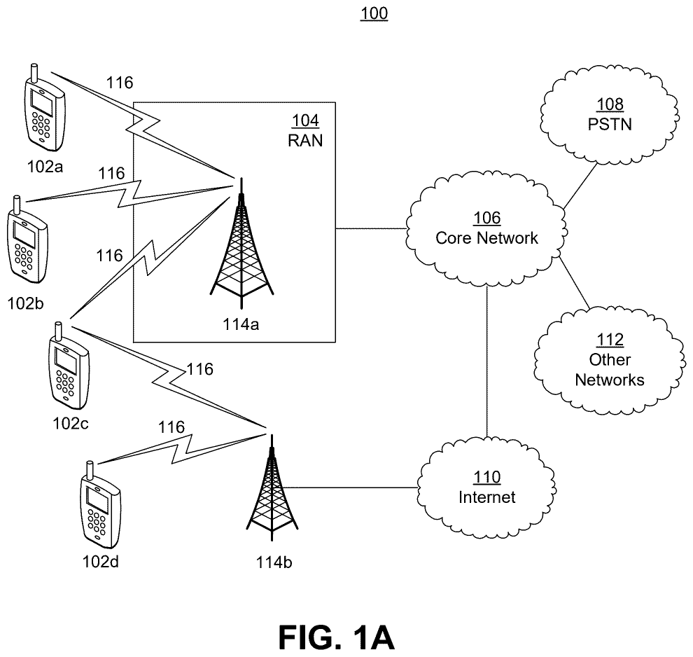

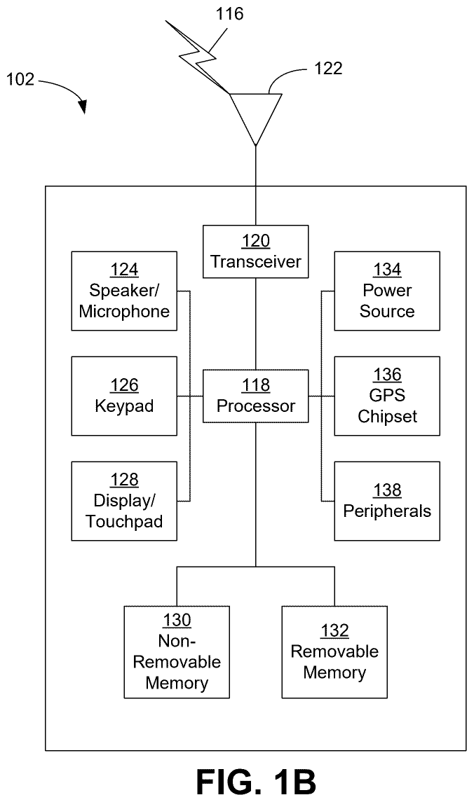

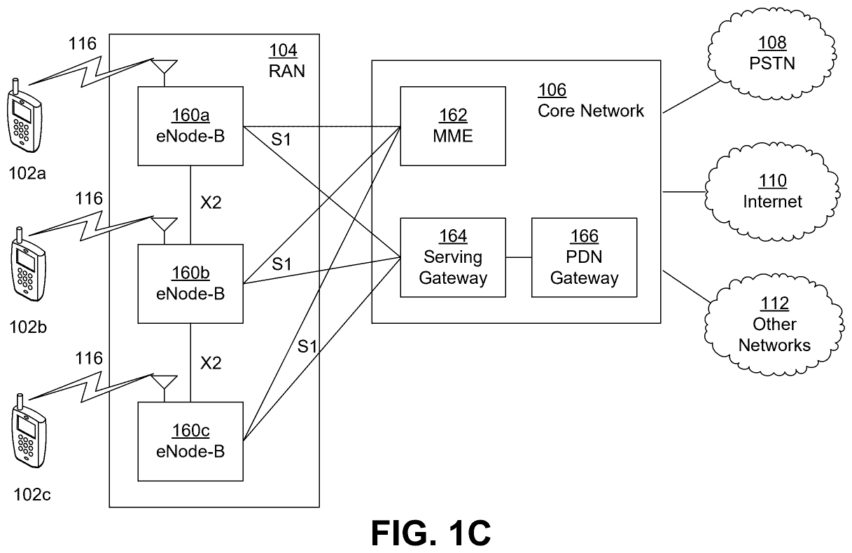

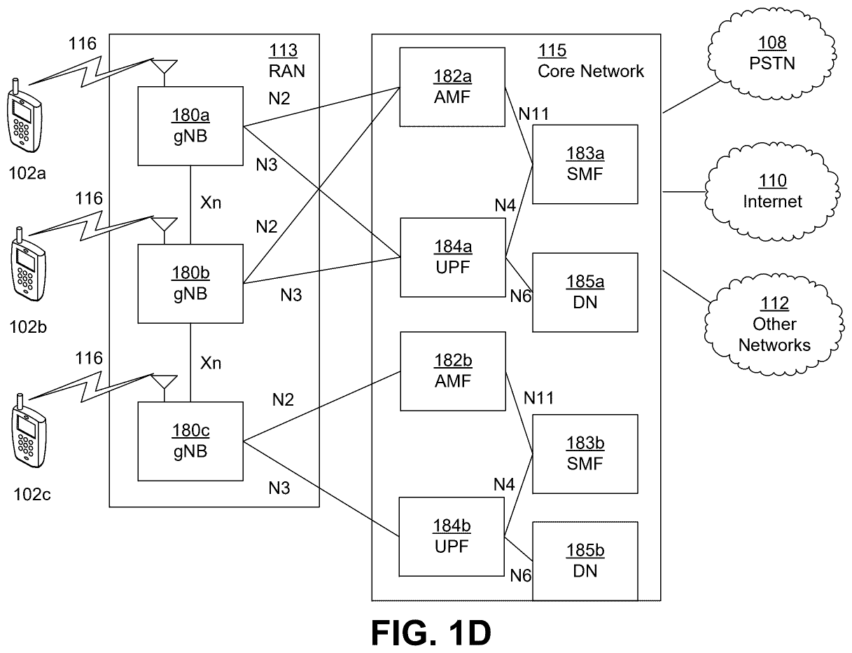

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In RAN #102, a RAN work item on Artificial Intelligence (AI)/Machine Learning (ML) for NR air interface was agreed. As one of the target use-cases for AI/ML for air interface, beam management was selected. This technology may be a foundation in improving performance and complexity in conventional beam management aspects, including beam prediction in time, and/or spatial domain for overhead and latency reduction, beam selection accuracy improvement, etc.

In NR, a wireless transmit/receive unit (WTRU) reports the best beams based on the received CSI report configurations. The WTRU reports the best beams via reporting corresponding CRI and/or SSBRI in UCI, where the bitwidth for CRI, SSBRI, RSRP, differential RSRP, and CapabilityIndex reporting is provided in Table 1:

TABLE 1
CRI, SSBRI, RSRP, and CapabilityIndex

| Field | Bitwidth |
|---|---|
| CRI | [log₂(Kₛ^{CSI-RS})] |
| SSBRI | [log₂(Kₛ^{SSB})] |
| RSRP | 7 |
| Differential RSRP | 4 |
| CapabilityIndex | 2 |

Table1 illustrates an example of bitwidth in UCI for reporting CSI, SSBRI, RSRP, differential RSRP, and CapabilityIndex.

In NR, there are priority rules indicated for CSI reports. An example method for calculating the priority values for CSI reports may be disclosed herein. These examples are non-limiting examples of the priority configurations and parameters. One or more of those configurations may be included. Other configurations may be included.

The CSI reports are associated with a priority value Pri_{iCSI}(y, k, c, s)=2·N_{cells}·Mₛ·y+N_{cells}·Mₛ·k+Mₛ·c+s where y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH; k=0 for CSI reports carrying L1-RSRP or L1-SINR and k=1 for CSI reports not carrying L1-RSRP or L1-SINR; c is the serving cell index and N_{cells} is the value of the higher layer parameter maxNrofServingCells (e.g., for a CSI report configured with LTM-CSI-ReportConfig, c is the serving cell index value where the report configuration is configured); and s is the reportConfigID and Mₛis the value of the higher layer parameter maxNrofCSI-ReportConfigurations (e.g., for a CSI report configured with LTM-CSI-ReportConfig, s is the LTM-CSI-ReportConfigID and Ms is the value of the higher layer parameter maxNrofLTM-CSI-ReportConfigurations). A first CSI report is said to have priority over second CSI report if the associated Pri_{iCSI}(y, k, c, s) value is lower for the first report than for the second report.

In NR-AIML, Rel. 19, the methods on reporting the applicable functionalities and the inference reporting for the WTRU-sided AIML models has been discussed. Some progress has been made to date with regards to applicable functionality reporting for beam management WTRU-sided model, with one or more agreements and assumptions being made in 3GPP RAN2.

For example, RAN2 agreed the following understandings on terminologies: Supported functionalities refer to functionalities that the WTRU can indicate by using WTRU capability information (e.g., via RRC/LPP signalling), applicable functionalities refer to functionalities that the WTRU is ready to apply for inference; and activated functionalities refer to functionalities already enabled for performing inference.

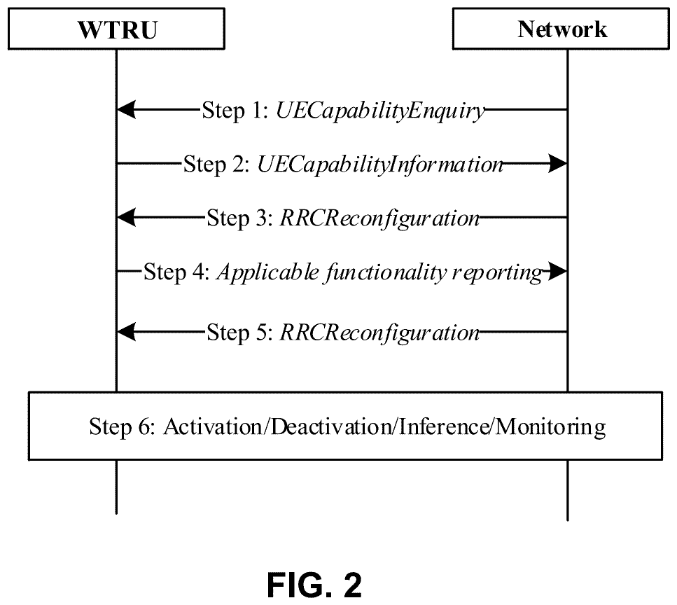

RAN2 further has made agreements and signalling procedure (e.g., as shown in FIG. 2) on applicable functionality reporting for beam management WTRU-sided model. FIG. 2 shows an example of applicable functionality reporting for beam management WTRU-sided model.

As shown in FIG. 2, a network (NW) sends UECapabilityEnqiry message to initiate the procedure to a WTRU reporting its AI/ML supported functionalities. The WTRU sends UECapablityInformation message to network, containing supported functionalities at the WTRU side. One or more of the following configurations are provided from the NW to the WTRU: the WTRU is allowed to do UAI reporting via OtherConfig, and/or the network may provide NW-side additional condition(s). For example, these configurations may be configured separately from the RRCReconfiguration information element (IE) shown in FIG. 2. The RRCReconfiguration IE may be used for operation based on AIML models and/or regarding the corresponding functionalities. The WTRU may decide the applicable functionalities based on NW-side additional conditions (e.g., if provided), WTRU-side additional conditions (e.g., internally known by the WTRU), and/or model availability in the device. Other configurations (e.g., inference configurations) may be considered by the WTRU. The WTRU may report the applicable functionality in the following scenarios: upon being configured to provide applicable functionality and upon change of applicable functionality via UAI, and/or as a response to NW-side additional condition requesting applicable functionality reporting. The network may configure an inference configuration to WTRU after applicable functionality reporting (e.g., if inference configuration based on supported functionality is not provided earlier). If inference configuration based on supported functionality is provided earlier, an updated configuration may be provided.

The applicable functionality may be activated by receiving its inference configuration when it is provided. NW-side additional condition may be assumed as associated ID in RAN2.

The WTRU may report to the NW when an applicable AI functionality becomes non-applicable. When a functionality configured by the network to be reported via UAI becomes from non-applicable to applicable (e.g., or vice versa) the WTRU may report it to the network. When a functionality becomes non-applicable the WTRU may not autonomously deactivate. The NW may be expected to deactivate active functionality when it receives a report from the WTRU that it is non-applicable.

Some progress has been made to date with regards to applicable functionality reporting for beam management WTRU-sided model, with one or more agreements and assumptions being made in 3GPP RAN1.

The concept/terminology “functionality” of supported functionalities may refer to WTRU-capability information/parameters (e.g., Rel-19 AI/ML-enabled Features/FGs). The concept/terminology “functionality” of applicable functionalities may refer to CSI-ReportConfig for inference configuration or a set of inference related parameters. The activated functionalities may be enabled based on CSI framework. Therefore, the meaning and the granularity of “functionality” for applicable functionalities, activated functionalities and supported functionalities may or may not be the same.

For beam management, multiple CSI reports for inference for a WTRU-side model may be configured/activated/triggered, which is up to the WTRU capability.

One or more of the following configurations may be provided from the NW to the WTRU. The WTRU may be allowed to do UAI reporting via OtherConfig. An applicability report is based on one or more of the following: one or more of CSI-ReportConfig for inference configuration (e.g., wherein the associated ID may be configured in CSI framework as working assumption applied), and/or one or more sets of inference related parameters for applicability report only (e.g., not for inference). The CSI report configuration for WTRU-side model inference may not be activated (e.g., immediately) upon receiving the one or more configurations. The set of inference related parameters selected from the IEs in/or the IEs referred by CSI-ReportConfig as a starting point may include, for example, the associated ID (e.g., which may not imply the associated ID is mandatory), Set A related information, Set B related information, report content related information, and/or (e.g., for BM-Case 2) one or more time instances related to information for measurements and/or prediction.

The WTRU may report applicability for one or more (e.g., all) of the CSI-ReportConfig and/or set(s) of inference related parameters. If the CSI-ReportConfig is configured, an applicable aperiodic CSI Report and semi-persistent CSI report may be activated/triggered by NW after the applicability is reported and/or the applicable periodic CSI Report may be considered as activated (e.g., only) if the applicability of the corresponding CSI-ReportConfig is reported in RRCReconfiguration Complete.

The NW may (e.g., optionally) configure CSI-ReportConfig for inference configuration in RRCReconfiguration, where the associated ID may be configured in CSI framework as working assumption applied. For the CSI-ReportConfig for inference configuration, aperiodic CSI Report and semi-persistent CSI report may be activated/triggered by the NW after RRCReconfigurationComplete, and/or a periodic CSI Report may be considered as activated after RRCReconfigurationComplete. The WTRU may not be expected to be configured with a CSI-ReportConfig for inference configuration for a non-applicable set of inference parameters or a non-applicable CSI-ReportConfig. The content of NW-side additional condition(s) may be determined. Associated IDs may be supported, and may be used to ensure the consistency of NW-side additional condition across training and inference for WTRU-sided model for BM-Case 1 and BM Case 2. The WTRU may assume the similar properties of a DL Tx beam or beam set/list associated with the same associated ID, while whether/how to define similar properties of a DL Tx beam or beam set/list may be determined.

In wireless transmit/receive unit (WTRU)-sided AIML models, inference may be performed at the WTRU. As such, the WTRU decides the applicable functionalities based on NW-side additional conditions (e.g., if provided), WTRU-side additional conditions (e.g., internally known by the WTRU), and/or model availability in device. As the WTRU is using an AIML model corresponding to a functionality, the WTRU may realize that the AIML model is not applicable anymore. A procedure to indicate the non-applicability may be desired. For example, in WTRU-side AIML models, the non-applicability of a functionality may be indicated based on a CSI Report framework.

Systems, methods, and instrumentalities for reporting non-applicable functionalities for WTRU-side AIML models are disclosed herein. One or more of the methods disclosed herein may be implemented by a wireless transmit/receive unit (WTRU) and/or a UE, for example via a processor thereof.

A WTRU may realize that due to changes in channel, the WTRU's speed, LOS, etc., the WTRU cannot perform the required CSI measurement and reporting (e.g., with regards to beam management). Upon determining the non-applicability of a first functionality, the WTRU may initiate a timer. The WTRU may continue to send (e.g., inaccurate) CSI reports while indicating the non-applicability to the gNB (e.g., via MAC-CE). If the non-applicability continues and the timer elapses, the WTRU indicates the non-applicability and a potential applicable candidate functionality to the gNB (e.g., via UE-assisted information (UAI)).

Instead of immediate fallback to non-AIML operation, the WTRU may give some time for the gNB to indicate the WTRU's action. Based on the report, gNB may realize that the received CSI reports are not accurate enough. As such, the gNB may send an indication to the WTRU to fall back to non-AIML procedure or use a second (e.g., new) applicable functionality.

The WTRU may receive one or more sets of CSI report configurations (e.g., for beam management) based on WTRU-side AIML models, where the received sets of CSI report configurations may be associated with one or more (e.g., first) functionalities in AIML models.

The WTRU may consider a first functionality as applicable based on one or more conditions (e.g., the WTRU's speed, LOS, etc. being with configured ranges). If one or more of the conditions are out of the configured ranges, the WTRU may consider the first functionality as non-applicable.

If the functionality that is associated with a CSI report is determined to be non-applicable, the WTRU may initiate a timer based on a determined and/or (pre)configured time value.

The WTRU may determine the priority level for the non-applicable CSI reports equal to a (pre)configured and/or MAX value (e.g., lowest priority).

The WTRU may send the CSI reports including inaccurate (e.g., predicted) values. The WTRU may also send an (e.g., first) indication on non-applicability of the corresponding functionality (e.g., by indicating the determined priority value) for the reported CSI (e.g., via MAC-CE). For example, the WTRU may transmit an indication that the first functionality is non-applicable to the network.

The WTRU may continue transmitting the CSI report (e.g., in addition to the non-applicability indication) until the functionality is again applicable or until the timer elapses.

If the timer elapses, the WTRU may send an (e.g., second) indication (e.g., in UAI) (e.g., via RRC) on non-applicability of the corresponding functionality. The WTRU may send an indication suggesting a new applicable candidate functionality to the network (e.g., gNB).

The WTRU may receive indication(s) from the network (e.g., via RRC) to fallback to non-AIML operation, use a second applicable functionality, etc.

The WTRU may use the second applicable functionality to predict the best beams and report the beams based on the configured CSI report configurations.

Hereinafter, “a” and “an” and similar phrases are to be interpreted as “one or more” and “at least one.” Similarly, any term which ends with the suffix “(s)” is to be interpreted as “one or more” and “at least one.” The term “may” is to be interpreted as “may, for example.”

A symbol “/” (e.g., a forward slash) may be used herein to represent “and/or,” where, for example, “A/B” may imply “A and/or B.”

The terms “prediction” and “estimation” may be used interchangeably herein (e.g., consistent with the embodiments disclosed herein).

The terms “candidate cell,” “neighbor cell,” and “target cell” may be used interchangeably herein (e.g., consistent with the embodiments disclosed herein).

The terms “source cell,” “current cell,” and “serving cell” may be used interchangeably herein (e.g., consistent with the embodiments disclosed herein).

Artificial intelligence (AI) may be broadly defined as the behavior exhibited by machines. Such behavior may e.g., mimic cognitive functions to sense, reason, adapt and act.

Machine learning (ML) may refer to a type of algorithms that solve a problem based on learning through experience (“data”), without explicitly being programmed (“configuring set of rules”). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein a (e.g., each) training example may be a pair consisting of input and the corresponding output. For example, an unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (e.g., with no labeled training data) and supervised learning (e.g., with only labeled training data).

Deep learning may refer to a class of machine learning algorithms that employ artificial neural networks (specifically DNNs) which were loosely inspired from biological systems. Deep Neural Networks (DNNs) are a special class of machine learning models inspired by human brain, wherein the input is linearly transformed and passed through non-linear activation function multiple times. DNNs typically consists of multiple layers, where a (e.g., each) layer consists of linear transformation and a given non-linear activation functions. The DNNs can be trained using the training data via back-propagation algorithm. Recently, DNNs have shown state-of-the-art performance in a variety of domains (e.g., speech, vision, natural language etc.) and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

Herein, the term “AIML model” may refer to an implementation of an AIML-based method which is made up of 1) model parameters and 2) the model structure. For example, a DNN-based AIML model may consist of the model parameters (e.g., weights and biases) and the model structure (e.g., the types and sizes of each layer of the deep neural network such as dense layers, convolutional layers, etc.).

Consistency between training and inference may be disclosed herein. A given AIML model may be trained under certain WTRU- and/or network-side additional conditions. For example, a WTRU-side condition may be the speed of the WTRU. Network-side additional conditions may be related to some network configurations/settings that the WTRU may not be aware of but may impact the performance of the model. For example, a beam prediction model may perform differently if it is trained when the network was using a certain antenna pattern, beam pattern, power levels, etc. Also, there may be aspects related to network load, that may have impact on the model performance.

Since the WTRU may not know all the details of the network-side additional conditions (e.g., and the network may also not want to expose some of these implementation), the network may hide these details by signaling to the WTRU one or more associated ID(s). For example, when data is being collected for training a model, tagging may be performed indicating under which network-side additional conditions the model is being trained. When a WTRU is being configured to perform the AIML based operation (e.g., beam prediction), it may be configured to check the consistency between the conditions under which the AIML model is trained on and current conditions (e.g., current WTRU conditions, current associated ID(s) signaled by the network indicating current network conditions/settings, etc.).

Herein, it may be assumed that under normal conditions the WTRU may be performing the AIML based operations (e.g., beam prediction) if it has an AIML model that is applicable to the current WTRU- and network-side additional conditions (e.g., or at least a model that is tested to perform good enough for the current WTRU- and network-side additional conditions). For example, the network may have communicated the current associated ID(s), and the WTRU may have indicated that it has a model that works under the current WTRU conditions and associated ID(s), and based on that the network may activate the AIML functionality at the WTRU. However, the applicability may change while the functionality is being used (e.g., due to a change in WTRU-side additional conditions such as WTRU speed) or the change of the network-side additional condition (e.g., the associated ID of the current cell changes, the WTRU is handed over to a cell that has a different associated ID that the one that was being used in the source cell, etc.). One or more of the embodiments herein may describe how to handle this scenario.

Life cycle management (LCM) may be disclosed herein. The term Life cycle management (LCM) may be used to describe the overall management aspects of AI/ML models, including, but not limited to: model training; functionality/model identification; model delivery/transfer; model inference operation; functionality/model selection, activation, deactivation, switching, and fallback operation; functionality/model monitoring; model update; WTRU capability; and/or data collection (e.g., for model training, for monitoring, for inference, etc.). Functionality/model selection, activation, deactivation, switching, and fallback operation may include a decision by the network (e.g., either network initiated or WTRU-initiated and requested to the network), a decision by the WTRU (e.g., event-triggered as configured by the network, WTRU's decision reported to the network, or WTRU-autonomous either with the WTRU's decision reported to the network or without it).

LCM may be functionality-based LCM or model-ID based LCM. In functionality-based LCM, the network indicates activation/deactivation/fallback/switching of AI/ML functionality via 3GPP signaling (e.g., RRC, MAC-CE, DCI). Models may not be identified at the network, and the WTRU may perform model-level LCM. The WTRU may have one or more AI/ML model(s) for the functionality.

In model-ID-based LCM, models are identified at the network, and the network/WTRU may activate/deactivate/select/switch individual AI/ML models via model ID.

In the functionality-based LCM, the WTRU may choose the AIML model to use for a certain functionality (e.g., the network decides for which functionalities the WTRU may use AIML-based operation, and the WTRU may choose the AIML model to use.

In the model-ID based LCM, the network may explicitly control which particular model is used for a given AIML functionality. For example, the WTRU may provide details of AIML models and their capabilities, and the network may determine which model to activate for a particular functionality.

One or more of the embodiments described herein are applicable to both model-ID based and functionality-based LCM. That is, the embodiments are related to how the WTRU determines whether it has a model that is applicable for the indicated associated ID(s). For example, in the case of functionality-based LCM, the WTRU may be configured/requested to determine if a given functionality is valid/applicable, and it will do the determination among one or more (e.g., all) the models it has for a given functionality and may consider the functionality applicable if at least one of the models is applicable. In another example, in the case of model-ID based LCM, the WTRU may be configured/requested by the network to determine whether a particular model is applicable or not.

An associated ID may be specific to a given functionality, or it may be applicable/common to more than one (e.g., or all) functionality(ies).

The WTRU may support several AIML models for a given functionality (e.g., with different prediction time horizons, prediction confidence levels, processing requirements, trained under/for operation in different frequencies/cells/location/times of day, etc.).

A given AIML model for a certain functionality may operate in different modes (e.g., with different levels of prediction confidence levels at different prediction time horizons, at different locations, frequencies, WTRU mobility pattern/speed, etc.).

The AIML models may be available at the WTRU already trained, or the WTRU may be provided with an untrained AIML model and may perform the training by itself.

The AIML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different WTRU speeds, etc.).

The AIML model may be available at the WTRU but not trained at all or (e.g., only) trained for certain WTRU/network conditions, and the WTRU may be configured to train the model (e.g., for the conditions that it is not trained for).

The WTRU may require some configurations/inputs that it needs for performing the inference using an AIML model. For example, for beam prediction, as disclosed herein, the WTRU may need to be configured with a certain number of beams/cells to measure to determine the prediction of other beams (e.g., set A/B configuration). In some cases, the WTRU may communicate the required configuration/input as part of the capability information. In other cases, the required configuration/input may be communicated to the network after capability request (e.g., based on explicit network request, if the WTRU gets configured to do AIML based beam, and it has determined that it is lacking the required configuration/input, etc.).

A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (e.g., target) physical channel or signal according to a spatial relation with a reference to the second (e.g., reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication.”

The WTRU may receive a first (e.g., target) downlink channel or signal according to the same spatial domain filter or spatial reception parameter as a second (e.g., reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication.”

Herein, a beam resource may consist of a TCI state, CSI-RS, a DL RS, or a SSB for downlink, and an SRS resource, an UL RS, or TCI state for uplink. A beam resource may be identified by a beam indication.

Hereafter, the term TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), consistent with the embodiments disclosed herein. Hereafter, the term Multi-TRP may be interchangeably used with one or more of MTRP, M-TRP, and multiple TRPs, consistent with the embodiments disclosed herein.

A WTRU may report a subset of channel state information (CSI) components, where CSI components may correspond to one or more of a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and/or other channel state information such as at least rank indicator (RI), channel quality indicator (CQI), precoding matrix indicator (PMI), Layer Index (LI), and/or the like.

Channel and/or interference measurements may be performed. A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following: a CSI report configuration; a CSI-RS resource set; and/or one or more NZP CSI-RS Resources. The CSI report configuration may include one or more of a CSI report quantity (e.g., Channel Quality Indicator (CQI), Rank Indicator (RI), Precoding Matrix Indicator (PMI), CSI-RS Resource Indicator (CRI), Layer Indicator (LI), etc.); a CSI report type (e.g., aperiodic, semi-persistent, periodic); a CSI report codebook configuration (e.g., Type I, Type II, Type II port selection, etc.); and/or a CSI report frequency. The CSI-RS resource set may include one or more of the following CSI Resource settings: NZP-CSI-RS Resource for channel measurement; NZP-CSI-RS Resource for interference measurement; and/or CSI-IM Resource for interference measurement. The NZP CSI-RS resource may include one or more of an NZP CSI-RS Resource ID; a periodicity and/or offset; QCL Info and TCI-state; and/or Resource mapping (e.g., number of ports, density, CDM type, etc.).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included: SS-RSRP, CSI-RSRP, SS-SINR, CSI-SINR, RSSI, CLI-RSSI, and/or SRS-RSRP. Other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (REs) that carry the respective synchronization signal. In measuring the RSRP, power scaling for the reference signals may be required. If SS-RSRP is used for L1-RSRP, the measurement may be accomplished based on CSI reference signals in addition to the synchronization signals.

CSI-RSRP may be measured based on the linear average over the power contribution of the REs that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the REs that carry the respective synchronization signal divided by the linear average of the noise and interference power contribution. If SS-SINR is used for L1-SINR, the noise and interference power measurement may be accomplished based on resources configured by higher layers.

CSI-SINR may be measured based on the linear average over the power contribution of the REs that carry the respective CSI-RS divided by the linear average of the noise and interference power contribution. If CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth).

Sounding reference signals RSRP (SRS-RSRP) may be measured based on the linear average over the power contribution of the REs that carry the respective SRS.

Secondary synchronization signal reference signal received quality (SS-RSRQ) may be measured based on measurements on the reference signal received power (SS-RSRP) and received signal strength (RSSI). In an example, the SS-RSRQ may be calculated as the ratio of N×SS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.

CSI reference signal received quality (CSI-RSRQ) may be measured based on measurements on the reference signal received power (CSI-RSRP) and received signal strength (RSSI). In an example, the SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

Beam/CSI report configuration may be disclosed herein. A CSI report configuration (e.g., CSI-ReportConfigs) may be associated with a single BWP (e.g., indicated by BWP-Id), wherein one or more of the following parameters may be configured: CSI-RS resources and/or CSI-RS resource sets for channel and interference measurement; CSI-RS report configuration type, including periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; Time restrictions for channel and interference measurements; Report frequency band configuration (e.g., wideband/subband CQI, PMI, and so forth); Thresholds and modes of calculations for the reporting quantities (CQI, RSRP, SINR, LI, RI, etc.); Codebook configuration; Group based beam reporting; CQI table; Subband size; Non-PMI port indication; and/or Port Index, etc.

CSI-RS resource configuration may be disclosed herein. A CSI-RS Resource Set (e.g., NZP-CSI-RS-ResourceSet) may include one or more of CSI-RS resources (e.g., NZP-CSI-RS-Resource and CSI-ResourceConfig), wherein a WTRU may be configured with one or more of the following in a CSI-RS Resource: CSI-RS periodicity and slot offset for periodic and semi-persistent CSI-RS resources; CSI-RS resource mapping to define the number of CSI-RS ports, density, CDM-type, OFDM symbol, and/or subcarrier occupancy; The bandwidth part to which the configured CSI-RS is allocated; and/or the reference to the TCI-State including the QCL source RS(s) and/or the corresponding QCL type(s).

RS resource set configuration may be disclosed herein. One or more of the following configurations may be used for RS resource set. A WTRU may be configured with one or more RS resource sets. The RS resource set configuration may include one or more of following: an RS resource set ID; one or more RS resources for the RS resource set; repetition (e.g., on or off); aperioidic triggering offset (e.g., one of 0-6 slots); and/or TRS info (e.g., true or not).

RS resource configuration may be disclosed herein. One or more of following configurations may be used for RS resource. A WTRU may be configured with one or more RS resources. The RS resource configuration may include one or more of following: a RS resource ID; Resource mapping (e.g., REs in a PRB); Power control offset (e.g., one value of −8, . . . , 15); Power control offset with SS (e.g., −3 dB, 0 dB, 3 dB, 6 dB); Scrambling ID; Periodicity and offset; and/or QCL information (e.g., based on a TCI state).

A grant or an assignment may have one or more properties. Herein, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

Herein, an indication by DCI may consist of at least one of the following: an explicit indication by a DCI field or by RNTI used to mask or scramble CRC of the DCI; and/or an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Receiving or monitoring for a DCI with or using an RNTI may mean that the CRC of the DCI is masked or scrambled with the RNTI.

A scheduling request (SR) may have one or more properties. The WTRU may use an SR for requesting UL-SCH resources for a new transmission. The WTRU may use SR for sending one or more requests, indications, and/or reports, for example to a network (e.g., gNB). The WTRU may be configured with zero, one, or more SR configurations. An SR configuration may consist of a set of PUCCH resources for SR across different BWPs and/or cells. In an example, the WTRU may be configured with at most one PUCCH resource for SR per BWP, for example for a logical channel or for secondary cell (SCell) beam failure recovery and/or for consistent LBT failure recovery. In another example, the WTRU may be configured with up to two PUCCH resources for SR per BWP, for example for beam failure recovery of BFD-RS set(s) of Serving Cell.

A (e.g., each) SR configuration may correspond to one or more logical channels, SCell beam failure recovery, consistent LBT failure recovery, beam failure recovery of a BFD-RS set, etc. In an example, each logical channel, SCell beam failure recovery, beam failure recovery of a BFD-RS set and consistent LBT failure recovery, may be mapped to zero or one SR configuration, which may be configured via RRC.

Herein, a signal may be interchangeably used with one or more of the following: Sounding reference signal (SRS); Channel state information-reference signal (CSI-RS); Demodulation reference signal (DM-RS); Phase tracking reference signal (PT-RS); and/or Synchronization signal block (SSB), consistent with the embodiments disclosed herein

Herein, the term channel may be interchangeably used with one or more of following: physical downlink control channel (PDCCH), physical downlink shared channel (PDSCH), Physical uplink control channel (PUCCH), Physical uplink shared channel (PUSCH), Physical random access channel (PRACH), etc., consistent with the embodiments disclosed herein

Herein, the terms “signal,” “channel,” and “message” (e.g., as in DL or UL signal, channel, and message) may be used interchangeably, consistent with the embodiments disclosed herein.

Herein, the term “RS” may be used interchangeably with one or more of “RS resource,” “RS resource set,” “RS port,” and “RS port group,” consistent with the embodiments disclosed herein.

Herein, the term “RS” may be used interchangeably with one or more of “RS resource,” “SSB,” “CSI-RS,” “SRS,” “DM-RS,” “TRS,” “PRS,” and “PTRS,” consistent with the embodiments disclosed herein.

Herein, the terms “time instance,” “slot,” “symbol,” and “subframe” (e.g., or “sub-frame”) may be used interchangeably, consistent with the embodiments disclosed herein.

Herein, the terms “SSB,” “SS/PBCH block,” “PSS,” “SSS,” “PBCH,” and MIB may be used interchangeably, consistent with the embodiments disclosed herein.

Herein, the terms “SSB,” “SSB beam,” and “SSB index” may be used interchangeably, consistent with the embodiments disclosed herein.

Herein, estimation and/or prediction may be used for transmissions and/or receptions belonging to a single or multiple cells, inter-cell, intra-cell, as well as single or multiple TRPs, consistent with the embodiments disclosed herein.

Herein, CSI reporting may be interchangeably used with CSI measurement, beam reporting and beam measurement, consistent with the embodiments disclosed herein.

Herein, an RS resource set may be interchangeably used with a beam group, consistent with the embodiments disclosed herein.

Herein, the terms “prediction,” “estimation,” “calculation,” “evaluation,” and “determination” may be used interchangeably, consistent with the embodiments disclosed herein.

Herein, RSRP may be used interchangeably with SS-RSRP, CSI-RSRP, SRS-RSRP, RSRP measured based on DMRS in PBCH, RSRP measured based on DMRS in PDCCH, RSRP measured based on DMRS in PDSCH, RSRP measured based on DMRS in PUCCH, RSRP measured based on DMRS in PUSCH, etc., consistent with the embodiments disclosed herein.

The term “functionality” may be used in one or more modes of operation, applications, and/or procedures herein. In an example, the functionality may be used with regards to AIML systems. For example, the WTRU may use AIML models for predicting one or more parameters, states, and/or values. In an example, the WTRU may use the AIML model for predicting the best beams, WTRU's position, one or more CSI parameters, etc. The functionality may imply different meanings based on the context.

The term “supported functionality” may be used herein. In an example, the supported functionalities may include one or more of WTRU capability information and/or parameter(s). The WTRU may receive one or more requests for reporting supported functionalities (e.g., via UECapabilityEnqiry), where the WTRU may report WTRU capabilities (e.g., via UECapablityInformation). For example, the WTRU may indicate one or more supported functionalities based on WTRU capabilities, where the WTRU may report the supported functionalities based on one or more features, feature-groups (FG), etc. In an example, the WTRU may report one or more supported AIML functionalities via one or more AIML-enabled features, FGs, etc.

The term “applicable functionality” may be used herein. In an example, the WTRU may receive, be configured, and/or indicated with one or more CSI report configurations. In an example, the configured and/or indicated CSI report configurations may be associated with one or more functionalities (e.g., a first functionality of the one or more functionalities). For example, the WTRU may receive the CSI report configurations via RRC, MAC-CE, DCI, etc., for example from a network (e.g., gNB). The WTRU may report one or more applicable functionalities, where the reported applicable functionalities may include one or more functions, information, and/or parameters that the WTRU may consider valid to be used and/or applied with regards to WTRU's operation. For example, the WTRU may report one or more (e.g., AIML) applicable functionalities including indications and/or indexes of one or more of the associated CSI report configurations (e.g., CSI-ReportConfigs). By reporting the applicable CSI report configurations, the WTRU may indicate that the WTRU can support the associated functionality. That is, the WTRU can support the requirements of the configured CSI report configurations and that the reported CSI parameters in the applicable CSI report configurations are accurate and/or valid.

For example, a WTRU may be configured with first and a second CSI report configurations for reporting one or more determined, estimated, and/or predicted CSI parameters (e.g., best CRI, SSBRI, etc.). The CSI report configurations may include the periodicity to report and the number of CRIs and/or SSBRIs to be reported, and so forth. In this case, if the WTRU is capable of accurately predicting the required first number of CRIs and/or SSBRIs as frequently as required by the first CSI report configuration, the WTRU may indicate the first CSI report configuration as applicable. However, if the WTRU cannot perform the predictions for the second number of CRIs and/or SSBRIs, if the predictions are not accurate enough, and/or if the WTRU cannot support the second periodicity, the WTRU may indicate the second CSI report configuration as non-applicable.

In another example, the WTRU may report one or more sets of inference related parameters as the applicable functionalities, where the WTRU may consider valid to be used and/or applied with regards to WTRU's operation. For example, the WTRU may report according to one or more of the following: if the WTRU has speed S1, the WTRU may measure up to N1 CSI-RSs and may predict and report up to M1 CSI-RS reports, every T1 msec; if the WTRU has speed S2, the WTRU may measure up to N2 CSI-RSs and may predict and report up to M2 CSI-RS reports, every T2 msec; etc. That is, the WTRU may report some parameters that are related to its inference capabilities. The NW may expect that if the gNB configures the WTRU within those parameters, the predictions at the WTRU-side are accurate and valid. For example, the WTRU may report one or more AIML applicable functionalities including one or more inference related parameters, where the parameters may include the size of inputs to the AIML model (e.g., Set B), size of outputs from AIML model (e.g., Set A), the periodicity of receiving the inputs to the AIML model, the periodicity of reporting outputs of AIML model, WTRU's speed, probability of LOS, etc. By reporting the applicable sets of inference-related parameters, the WTRU may indicate that the WTRU can support accurate results from AIML model based on the reported applicable inference parameters. For example, the WTRU may indicate a first set of applicable inference-related parameters, based on which the WTRU may provide valid and accurate AIML inference results. If the WTRU is configured and/or indicated to apply the AIML model based on the second inference-related parameters that are different from the first set, the WTRU may indicate that the second set of inference-related parameters are non-applicable.

The term “activated functionality” may be used herein. In an example, the WTRU may determine, receive, be configured, and/or indicated with one or more indications on activating one or more functionalities, where the reported applicable functionalities may include one or more functions, information, and/or parameters. For example, the WTRU may receive the indications on activated functionalities via SIB, RRC, MAC-CE, DCI, etc., for example from a network (e.g., gNB). In an example, the indication of the activated functionalities may include indications of one or more activated CSI report configurations in addition to corresponding indexes. After receiving the indications of the activated functionalities (e.g., activated CSI report configurations), the WTRU may use the configured corresponding CSI report configurations for measuring the configured and/or indicated CSI-RS resources, CSI-RS resource sets, CSI-IM resources, etc. and predicting one or more parameters to be reported based on the activated CSI report configurations.

Applicable functionality reporting may be disclosed herein. The WTRU may be configured with the procedure for reporting the supported functionalities, applicable functionalities, and/or receiving the indications on activated functionalities, where one or more of the following may apply. The WTRU may receive one or more requests for reporting one or more supported functionalities (e.g., via UECapabilityEnqiry). The WTRU may send a report indicating one or more supported functionalities (e.g., via UECapablityInformation). The WTRU may receive one or more indications on one or more functionalities to be considered, used, and/or applied with the AIML models. In an example, the WTRU may receive one or more CSI report configurations for inference configuration. For example, the WTRU may receive the associated ID as part of the received configurations. In another example, the WTRU may receive one or more sets of inference related parameters. The WTRU may report the applicability for one or more received CSI report configurations and/or one or more sets of inference related parameters. The WTRU may receive indications on one or more activated functionalities. For example, the WTRU may receive indications on the activation of one or more applicable CSI report configurations, for example via RRC reconfiguration signaling.

In an example, a WTRU may autonomously deactivate one or more functionalities and/or send a configured corresponding report (e.g., to a gNB) when the WTRU determines applicability has changed, etc. The applicability change may be due to the change in WTRU-side conditions such as speed changes, and the WTRU may have no model trained for those conditions. Alternatively, the applicability change may be due to the associated ID changes, and the WTRU may have no model trained for the new associated ID, where the associated ID change may be due to the WTRU performing a HO to a cell that is operating under different network conditions, or the network changing some of its configurations without the WTRU performing a HO, etc.

Non-applicable functionalities may be reported. Configuration of functionalities and determining the non-applicability may be performed.

A WTRU may receive, be configured, and/or indicated with configuration information, for example including one or more inference-related parameters and/or CSI report configurations, for example associated with AIML models. In an example, the received configuration information may be regarding a WTRU-side AIML model. In an example, the WTRU may receive the configuration information via SIB, RRC, MAC-CE, DCI, etc. In an example, the received configuration information may be associated with one or more functionalities, for example in AIML systems.

The WTRU may send a report indicating one or more functionalities associated with the received configuration information as applicable. The WTRU may determine the applicability of the functionalities based on one or more conditions, for example NW-side additional conditions (e.g., if provided), WTRU-side additional conditions (e.g., internally known by the WTRU), model availability in the device, etc. In an example, the WTRU may receive one or more indications on activating one or more of the applicable functionalities.

In a solution, a WTRU may determine that a previously applicable functionality may not be applicable anymore based on one or more conditions. In an example, the WTRU may determine that one or more of the configured inference parameters is not valid or applicable anymore. In another example, the WTRU may determine that the WTRU is not capable to report the CSI based on the configured CSI report configurations associated with the corresponding functionality. One or more of the following example conditions may apply: based on measurements, change of WTRU-side additional conditions, change of network-side additional conditions, validity time window, model accuracy, technical issues in performing the inference, etc.

The one or more conditions may be based on measurements. For example, the WTRU may determine the non-applicability of a functionality based on one or more measurements. In an example, the WTRU may be configured with one or more CSI report configurations including one or more CSI-RS resources. The WTRU may measure the corresponding CSI-RS resources. The WTRU may report the measured parameters and/or trigger one or more events based on one or more conditions. For example, the WTRU may be configured with measuring RSRP based on one or more CSI-RS resources. In an example, the WTRU may report the measured RSRP (e.g., only) if it is lower/higher than a determined, configured, and/or indicated threshold value. In another example, the WTRU may be configured with an association with the measured RSRP and at least a functionality, where the WTRU may trigger the event on non-applicability of the associated functionality if the measured RSRP is lower/higher than a corresponding threshold.

In another example, the WTRU may be configured with one or more states and/or modes that may be associated with one or more functionalities. That is, the WTRU may measure and/or determine the states and/or modes and determine the applicability of the associated functionalities accordingly. In an example, the WTRU may determine the probability of LOS for a measured and/or predicted beam associated with a functionality. For example, the WTRU may determine the associated functionality to be non-applicable if the determined probability of LOS is lower than a threshold value.

The one or more conditions may include a change of WTRU-side additional condition(s). The WTRU may determine a certain functionality that was applicable is no longer applicable due to a change of a WTRU side additional condition (e.g., to a condition that the WTRU has no model trained for that functionality). For example, the WTRU may determine the WTRU's speed and/or mobility state associated with a functionality. For example, the WTRU may determine a functionality to be non-applicable if the WTRU's speed is higher than a threshold value. The WTRU may determine a functionality to be non applicable if the WTRU is not at a certain location and/or if the current time is not within a certain time window.

The one or more conditions may include a change of network-side additional condition(s). The WTRU may determine a certain functionality that was applicable is no longer applicable due to a change of a network side additional condition(s) (e.g., to a condition that the WTRU has no model trained for that functionality). The WTRU may have provided one or more (e.g., all) of the network-side additional conditions (e.g., associated IDs) that a certain functionality is applicable for to the network so the network may implicitly know when/if a functionality that was applicable become non-applicable due to a change in associated ID at the network. However, this can not be assumed all the time. For example, the WTRU may have a functionality that has a model that is trained for two associated IDs (e.g., A and B). If the functionality was applicable and activated at the moment when the associated ID was A, the functionality may not necessarily be applicable if the associated ID changes to B (e.g., due to the configuration of the current cell changing, the WTRU being handed over to another cell, etc.). For example, the WTRU may have models trained for that functionality for WTRU condition X and associated ID A, and WTRU condition Y and associated ID B, but not WTRU condition X and associated ID B.

The one or more conditions may include a validity time window. For example, the WTRU may determine the non-applicability of a functionality based on the validity time determined, configured, and/or indicated for the associated AIML model. In an example, the WTRU may determine a functionality as non-applicable if the associated AIML model has expired. That is, the WTRU may determine a functionality as non-applicable if the validity time window for the associated AIML model has expired and/or elapsed.

The one or more conditions may include a model accuracy. For example, the WTRU may determine the non-applicability of a functionality based on the AIML model's accuracy. In an example, the WTRU may consider a functionality as applicable if the AIML model used for deriving the corresponding parameters, values, and/or reports is valid and/or accurate. In another example, the WTRU may consider a functionality as non-applicable if the AIML model used for deriving the corresponding parameters, values, and/or reports is invalid and/or inaccurate.

The WTRU may evaluate and/or determine the AIML accuracy based on one or more performance monitoring occasions. The performance monitoring occasions may be based on measuring one or more quality parameters (e.g., RSRP) based on one or more transmitted reference signals (e.g., CSI resources, SSB, etc.), and comparing the results with the corresponding predicted values. That is, the WTRU may be configured with a set of CSI report configurations including one or more CSI-RS resources for performance monitoring and measuring.

The WTRU may use the configured CSI-RS resources for measuring one or more quality parameters (e.g., RSRP, RSRQ, SINR, etc.). The WTRU may compare the measured quality parameters with corresponding predicted values, and if the predicted values are within a determined, configured, and/or indicated range of the measured values, the predictions may be considered as valid and/or accurate. Otherwise, if the predicted values are not within the range of the measured values, the predictions may be considered as invalid and/or inaccurate. In an example, the WTRU may determine, receive, be configured, and/or indicated with one or more threshold values for determining the accuracy ranges.

Alternatively, the WTRU may use the measurements based on the configured CSI-RS resources for determining one or more (e.g., best) beams (e.g., top-k beams, top 1 beam, etc.). In an example, the WTRU may determine the top 1 beam based on the measurements, and if the determined top 1 beam is the same as the predicted top 1 beam, the AIML model may be considered as accurate and/or valid. Otherwise, if the predicted beam is different from the measured beam, the AIML model may be considered as invalid and/or inaccurate. In another example, the WTRU may determine the top-k beams based on the measurements, and if at least a (pre)configured number (e.g., M) of predicted beams are within the measured top-k beams, the AIML model may be considered as accurate and/or valid. Otherwise, the AIML model may be considered as invalid and/or inaccurate. It should be noted that for any of the embodiments disclosed herein regarding the performance-based determination of the applicability of a functionality, there may be an associated time to trigger to check if the performance fulfills the requirements or not. For example, the WTRU may be configured with a certain time duration threshold, and if the performance doesn't meet the required quality metric threshold for a duration longer than the time duration threshold, the WTRU may consider the functionality non-applicable. In another example, instead of (e.g., or in addition to) the time duration threshold, a counter threshold may be configured (e.g., if the number of times the required metric threshold is not met within the time duration is above the counter, the WTRU may consider the functionality as not applicable any more.

The one or more conditions may include technical issues in performing the inference. For example, the WTRU may determine the non-applicability of a functionality based on the technical issues in applying the associated AIML models. In an example, in case of memory shortage, the WTRU may determine that storing the measurements, downloading the AIML models, and/or performing inference based on AIML models is not possible. In this case, the WTRU may determine the associated functionality to be non-applicable. In another example, in case of CPU overload, the WTRU may determine that performing inference based on AIML models is not possible, thus the WTRU may determine the associated functionalities as non-applicable.

The WTRU may be configured to determine/re-check the applicability currently activated AIML functionalities in a periodic manner (e.g., at a configured periodicity). The periodicity may be the same for one or more (e.g., all) of the different set of functionalities or may be different from one functionality to another.

The WTRU may be configured to determine/re-check the applicability of currently activated AIML functionalities whenever it detects that the WTRU-side additional condition(s) (e.g., WTRU speed) has changed.

The WTRU may be configured to determine/re-check the applicability of the currently activated AIML functionalities whenever it detects that the network-side additional condition(s) (e.g., associated ID) has changed.

Modes of operation for reporting non-applicable functionality(ies) may be disclosed herein. A WTRU that has determined that a functionality is non-applicable may determine the mode of operation based on one or more conditions, events, threshold values, and so forth. For example, the WTRU may determine, receive, be configured, and/or indicated with one or more modes of operation. The WTRU may receive one or more configuration information and/or indications on one or more modes of operation, for example via SIB, RRC, MAC-CE, DCI, etc. A first mode of operation may be based on the WTRU continuing to send the reports. A second mode of operation may be based on the WTRU dropping, delaying, and/or omitting the reports. The WTRU may determine the mode of operation based on one or more of the following: CSI report payload, AIML accuracy, CSI report multiplexed with PUSCH, and/or technical issues in performing the inference.

The WTRU may determine the mode of operation based on a CSI report payload. For example, the WTRU may determine the mode of operation based on a CSI report's payload. The WTRU may evaluate and/or determine the CSI report payload based on the bitwidth required for reporting the CSI parameters and/or values based on the corresponding configured CSI report configuration. The WTRU may determine the number of the bits required for reporting the configured CSI. If the CSI report payload is lower than a threshold value, the WTRU may select the first mode of operation. If the CSI report payload is higher than the threshold value, the WTRU may select the second mode of operation.

The WTRU may determine the mode of operation based on an AIML accuracy. For example, the WTRU may determine the mode of operation based on the AIML model's accuracy. The WTRU may determine the AIML accuracy based on scaled values from a minimum to a maximum number (e.g., from 0 to 100), where the maximum number may indicate perfect valid accuracy, and the minimum number may indicate an invalid accuracy. If the evaluated AIML model accuracy is lower than a first accuracy threshold value, the WTRU may select the first mode of operation. If the evaluated AIML model accuracy is lower than a second accuracy threshold value, the WTRU may select the second mode of operation. For example, the second accuracy threshold value may be lower than the first.

The WTRU may determine the mode of operation based on a CSI report multiplexed with a PUSCH. For example, the WTRU may determine the mode of operation based on the channel to which the CSI report is multiplexed with. If the CSI report is multiplexed with PUSCH, the WTRU may select the second mode of operation.

The WTRU may determine the mode of operation based on technical issues in performing the inference. For example, the WTRU may determine the mode of operation based on the technical issues in applying the AIML models. In an example, in case of memory shortage, the WTRU may determine that storing the measurements, downloading the AIML models, and/or performing inference based on AIML models is not possible. In this case, the WTRU may select the second mode of operation. In another example, in case of CPU overload, the WTRU may determine that performing inference based on AIML models is not possible, and the WTRU may select the second mode of operation. Alternatively, the WTRU may determine that due to CPU shortage, (e.g., only) some parts of the CSI report can be predicted based on AIML models. As such, the WTRU may determine to operate based on the second mode of operation, where partial dropping may be applied.

A first mode of operation may be performed, where the WTRU may continue CSI report transmission. A WTRU may receive, determine, be configured, and/or indicated with one or more configuration information and/or indications to operate based on a first mode of operation when a functionality is determined to be non-applicable. For example, the WTRU may receive the configuration information and/or indications via SIB, RRC, MAC-CE, DCI, etc. In an example, the first mode of operation may be based on continuing to transmit the configured CSI reports based on one or more CSI report configurations that are associated with the non-applicable functionality. In an example, the WTRU may determine, be configured, and/or indicated to transmit inaccurate (e.g., inaccurately predicted) values in the transmitted CSI reports. In an example, the WTRU may determine, be configured, and/or indicated to not update the reported values and to transmit the same values in the transmitted CSI reports.

After determining the non-applicability of a functionality, a WTRU may initiate a timer with a determined, (pre)configured, and/or (pre) indicated time value. For example, the WTRU may continue to transmit the configured CSI reports based on one or more CSI report configurations that are associated with the non-applicable functionality until the timer elapses. In another solution, after determining the non-applicability of a functionality, the WTRU may consider a time-window to continue to transmit the configured CSI reports. The WTRU may determine, be configured and/or indicated with the duration of the time window, where the duration of the time window may be based on absolute time units (e.g., msec, usec, etc.) and/or the number of time instances (e.g., symbols, slots, etc.). The WTRU may receive configuration information and/or indications on the time value to be used for the timer and/or the time duration of the time window, e.g., via SIB, RRC, MAC-CE, DCI, etc.

The timer duration value may be configured to be dependent on the level of non-applicability (e.g., if the WTRU is doing the determination of the non-applicability based on performance levels/accuracy). The WTRU may further be configured with several accuracy thresholds, and timer values corresponding with each (e.g., no time duration, or time duration assumed to be infinity, if accuracy is above 95%, time duration of t1 if accuracy is between 85% and 95%, time duration of t2 if accuracy is between 75% and 85%, and time duration of t3=0 if accuracy is below 75%, etc.). In an example, instead of specifying different time duration values corresponding to a (e.g., each) performance KPI level/threshold/range (e.g., as in the previous example), the WTRU may be configured with a baseline time duration (e.g., for a certain specific KPI level/threshold/range), and it may derive the time duration to use for other KPI levels/thresholds/ranges as a function of the baseline time duration value and a scaling factor (e.g., where the scaling factor is a relative ratio between the baseline KPI level and the current KPI level, etc.).

The WTRU may determine, be (pre)configured, and/or indicated to calculate, determine, and/or evaluate the priority level for one or more CSI reports corresponding to one or more CSI report configurations that are associated with one or more non-applicable functionalities. In an example, the WTRU may determine, be configured and/or indicated to use a (pre)configured and/or indicated value for the priority level of the corresponding CSI reports. For example, the WTRU may determine, be configured and/or indicated to use a value indicating a low priority (e.g., a maximum value for the priority level of the corresponding CSI reports). That is, the WTRU may consider the corresponding CSI reports to have the lowest priority.

The priority level may be configured to be dependent on the level of non-applicability (e.g., if the WTRU is doing the determination of the non-applicability based on performance levels/accuracy). The WTRU may further be configured with several accuracy thresholds, and priority level(s) corresponding with an (e.g., each) accuracy threshold (e.g., highest priority if accuracy is above 95%, 2^{nd} highest priority if accuracy is between 85% and 95%, 3^{rd} highest priority if accuracy is between 75% and 85%, etc.). Instead of explicit priority levels for a (e.g., each) range of KPI thresholds, the WTRU may be configured with a scaling factor on how to do the down prioritization based on the current accuracy level and a baseline accuracy level.

The WTRU may report and/or send one or more indications to indicate the non-applicability and/or applicability failure (e.g., or reduction of level of applicability) of one or more functionalities (e.g., a first functionality). In an example, the WTRU may send the report and/or indication via RRC, MAC-CE, UCI, a special SR, a special HARQ-ACK, etc. For example, the WTRU may determine, be configured, and/or indicated with a (pre)configured set of resources for one or more special SR transmissions, where the WTRU may use the configured resources for indicating the non-applicability of the functionalities. In another example, the WTRU may determine, be configured, and/or indicated with a (pre)configured HARQ-ACK codebook, based on which the WTRU may indicate the non-applicability of the functionalities. The WTRU may indicate the ID of the non-applicable functionality. The WTRU may suggest, request, and/or indicate the ID of one or more new (e.g., second) applicable functionalities. For example, the WTRU may send the report and/or indications to a network (e.g., gNB). In another example, the WTRU may indicate the determined priority level of the corresponding CSI reports, for example via RRC, MAC-CE, UCI, etc. for indicating the non-applicability of the associated functionalities.

The WTRU may continue to transmit the configured CSI reports based on CSI report configurations that are associated with the non-applicable (e.g., first) functionalities based on one or more conditions. For example, the WTRU may continue transmitting (e.g., inaccurate) CSI reports until the WTRU determines that the functionality is again applicable. In this case, the WTRU may transmit the accurately determined and/or predicted CSI values via the configured CSI reports. In another example, the WTRU may continue transmitting (e.g., inaccurate) CSI reports until the corresponding timer elapses and/or the determined and/or configured time-window passes (e.g., as described herein). In this case, the WTRU may send an indication and/or report indicating the ID and information associated with the non-applicable functionality. The WTRU may send the information via UE-assistance information (UAI), for example via MAC-CE, RRC, UCI, etc. The WTRU may also indicate and/or suggest the ID of one or more (e.g., second) applicable functionalities.

The WTRU, upon detecting the time duration for continuing to transmit the CSI reports based on functionality application, may be further configured to perform a re-check/determination to verify if the functionality has become applicable again, but may not perform the applicability determination while the timer is running.

After indicating the non-applicability of a functionality, the WTRU may receive one or more indications (e.g., via RRC, MAC-CE, DCI, etc.) indicating the mode of operation. For example, the WTRU may receive, from the network, indications to fallback to non-AIML operation for the corresponding functionality. In this case, the WTRU may fall back to non-AIML operation, for example for beam management procedures. In another example, the WTRU may receive, from the network, one or more indications of one or more new applicable functionalities to be used. The WTRU may use the new applicable functionality for AIML operation, for example for beam management systems. For example, the WTRU may use the CSI report configurations associated with the new indicated applicable functionality for reporting one or more CSI reports.

The WTRU may be pre-configured with a fallback configuration (e.g., another AIML related configuration, a non-AIML based configuration, etc.) that is associated with a (e.g., one) AIML functionality. This may be specific for an (e.g., each) activated functionality, common for a certain group of functionalities (e.g., within a given use case or sub use case), or may be common at a use case or sub use case level. That is, instead of non-applicability indication disclosed herein, the WTRU may indicate (e.g., implicitly or explicitly) that it has switched to the fallback configuration that was associated with the functionality that was determined to have become non-applicable.

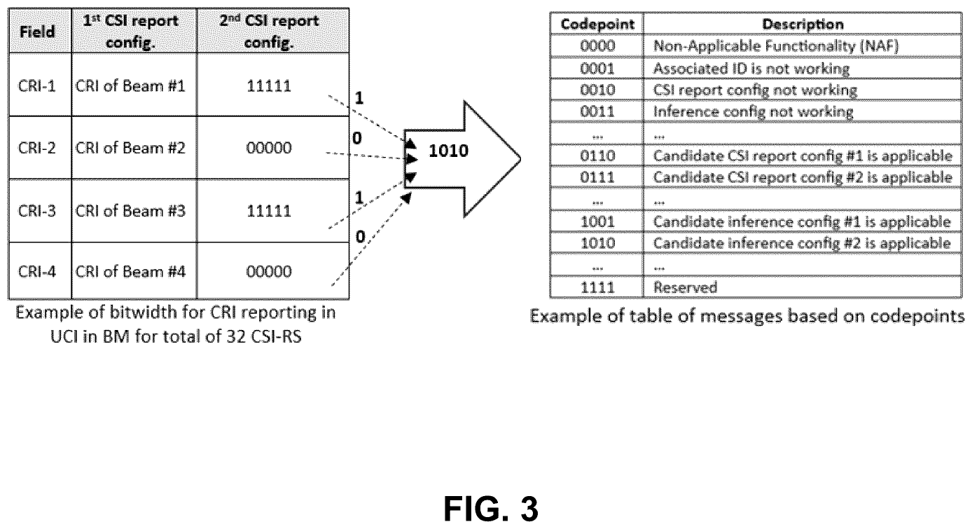

Non-applicability of one or more functionalities may be indicated as part of L1 signaling (e.g., via UCI). If a functionality that is associated with a CSI report is determined to be non-applicable, and if the WTRU is indicated and/or enabled to use L1-signaling, the WTRU may use the bits that were supposed to be used for reporting the CRI and SSB Index in the UCI for indicating the non-applicability. The WTRU may use a (e.g., each) entry for CRI/SSBRI reporting as a (e.g., single) bit, where a first value reported as the CRI/SSBRI indicates 0 and a second value reported as the CRI/SSBRI indicates 1 (e.g., the WTRU uses ALL-ONE to indicate the value of 1 and ALL-ZERO to indicate the value of 0). FIG. 3 shows an example of indicating codepoints via CRI signaling. As shown in FIG. 3, a first CRI may be ALL-ONE, a 2^{nd} CRI may be ALL-ZERO, a 3^{rd} CRI may be ALL-ONE, and a 4^{th} CRI may be also ALL-ZERO, meaning the WTRU is indicating index 1010 as the codepoint for indicating the non-applicability. There may be no ambiguities at the gNB (e.g., since ALL-ONE and ALL-ZERO will be indicated for more than one CRI/SSB-Index, the gNB realizes that this is not beam reporting and it is a codepoint indication). One or more (e.g., each) of the codepoints may (e.g., implicitly) indicate that the corresponding functionality is non-applicable.

After sending the report indicating the non-applicability, the WTRU may receive a request to report the applicable functionalities based on the new conditions. The WTRU may receive an indication/activation (e.g., via DCI or MAC-CE) indicating/activating one or more second sets of CSI report configurations. The second CSI report configuration may include a new parameter indicating that the second CSI report config is in response to the WTRU's indication of non-applicability. If the WTRU has transmitted a non-applicability status, the WTRU may accept the second CSI report config and use the second CSI report config if it is applicable. The WTRU may transmit a CSI report based on the second CSI report config and one or more measurements.

A WTRU may receive, determine, be configured, and/or indicated with one or more configuration information and/or indications to enable L1-signaling. The WTRU may use the L1-siganling for indicating one or more triggered events and/or event-based indications. In an example, the WTRU may use the L1-siganling for indicating one or more indications and/or reports in case of events where the WTRU may determine that one or more functionalities may not be non-applicable. For example, the WTRU may receive the configuration information and/or indications via SIB, RRC, MAC-CE, DCI, etc. The WTRU may send the L1-signaling via UCI, MAC-CE, RRC, etc.

The WTRU may determine, be configured, and/or indicated with one or more first CSI report configurations for reporting one or more measured, evaluated, estimated, predicted, and/or determined parameters and/or values. The WTRU may determine, be configured, and/or indicated with one or more second CSI report configurations for reporting and/or indicating one or more events and/or event-based indications. For example, the second CSI report config may be associated with the first CSI report config. The config ID for the first CSI report configuration may be indicated as part of the second CSI report configuration to indicate the association.

The WTRU may be configured with one or more events and/or event-based indications associated with the first and the second configured CSI report configurations. The events associated with the first CSI report configuration and the second CSI report configuration may be the same or different. The WTRU may determine, be configured, and/or indicated to use the first configured CSI report configuration if none of the associated events are triggered. If at least one of the associated events is triggered, the WTRU may stop using the first CSI report configuration. In another example, if at least one of the associated events is triggered, the WTRU may start using the second CSI report configuration. The time and frequency resources for reporting CSI reports corresponding to the first and second CSI report configurations may be the same or different.

The WTRU may be configured with one or more codepoints to be reported via the configured second CSI report configurations. The configured codepoints may be associated with one or more event-based indications in addition to corresponding information. The WTRU may report a first configured codepoint for indicating a first event, a second configured codepoint for indicating a second event, etc. The WTRU may report a third configured codepoint for indicating a first reason leading to the first event, a fourth configured codepoint for indicating a second reason leading to the first event, etc. The WTRU may report a fifth configured codepoint for suggesting and/or requesting a first mode of operation to be applied after the first event, a sixth configured codepoint for suggesting a second mode of operation to be applied after the first event, etc.

The WTRU may determine, be configured, and/or indicated to transmit one or more second CSI reports based on one or more repetition configurations. For example, the WTRU may transmit the CSI reports including the codepoints based on the second CSI report configuration in more than one occasions. That is, the WTRU may repeatedly transmit the CSI report including the codepoints based on second CSI report configurations. The repetition may increase the accuracy of L1-signaling and detection of the transmitted codepoints. For example, the WTRU may be configured to send the codepoint twice, three times, etc.

The WTRU may indicate that the WTRU is reporting a CSI report based on the second CSI report configurations. For example, the WTRU may send one or more flag indications to indicate the use of codepoints in the CSI report. In another example, the WTRU may send one or more flag indications to indicate the events and/or conditions, based on which the WTRU determined and/or selected to use the second CSI report configuration. The WTRU may send the indication(s) as part of the transmitted CSI report, via a special HARQ-ACK codebook, via MAC-CE, DCI, RRC, etc. signaling. The WTRU may indicate (e.g., via the indication) that the second CSI report configuration is used and that the CSI report includes the codepoint to indicate the event, condition, etc. (e.g., instead of normal CSI report bits).

The first configured CSI report configuration may correspond to reporting one or more (e.g., best) measured, determined, and/or predicted beam resources. For example, the first CSI report configuration may include reporting one or more (e.g., best) CRIs and/or one or more (e.g., best) SSBRIs. The first reportQuantity in the first CSI report configuration may be configured as “cri-RSRP” or “ssb-Index-RSRP”. The bitwidth corresponding to reporting the CRIs and/or SSBRIs is shown in FIG. 2, where K(CSI-RS) is the total number of CSI-RS resources and K(SSB) is the total number of SSBs. FIG. 2 is a non-limiting example of the parameters that may be included in CRI and/or SSBRI reporting. One or more of those parameters may be included. The number of bits and choices for each parameter are examples. Other numbers of bits or choices may be included. For example, a WTRU may be configured to report one or more (e.g., up to four) (e.g., best) CRIs out of 32 total CSI-RS resources, based on the first CSI report configuration. As such, based on FIG. 2, the WTRU may report four CRIs (e.g., each including five bits). FIG. 3 shows an example where a WTRU may report four CRIs based on the first CSI report configuration.

The second configured CSI report configuration may correspond to reporting one or more codepoints, for example instead of CSI reports in the first configured CSI report configuration. That is, instead of reporting the CRIs and/or SSBRIs as configured in the first CSI report configuration, the WTRU may use (pre)configured and/or (pre) determined codepoints. In an example, in a system with a total of 32 CSI-RS resources, instead of reporting up to four CRIs, the WTRU may report one or more (e.g., four) codepoints, where a (e.g., each) codepoint may include one or more (e.g., five) bits. The WTRU may use an ALL-ONE indication with one or more (e.g., five) consecutive 1s (e.g., 11111) to indicate a first value (e.g., value one), and an ALL-ZERO indication with one or more (e.g., five) consecutive 0s (e.g., 00000) to indicate a second value (e.g., value zero).

As such, using the ALL-ONE and/or ALL-ZERO indications, a WTRU may indicate one or more (e.g., up to four) bits (e.g., up to sixteen codepoints), based on the second CSI report configuration. For example, as shown in FIG. 3 the WTRU may report up to sixteen codepoints based on the second CSI report configuration. In the example shown in FIG. 3, the WTRU reports 11111, 00000, 11111, 00000 based on the second CSI report configuration. Such signaling may indicate the codepoint 1010 that can be used as a reference to a table to determine the indication that the WTRU is reporting.

A second CSI report configuration may be configured for indicating and/or signaling that one or more of the functionalities associated with a first associated CSI report configuration is non-applicable (e.g., is not applicable). For example, the codepoints may indicate one or more of the following example indications: non-applicable functionality (e.g., the WTRU may indicate the non-applicability of the associated functionality); associated ID is not working (e.g., the WTRU may indicate that the associated ID corresponding to the associated functionality is not working); CSI report config not working (e.g., the WTRU may indicate that the first CSI report configuration associated with the functionality is not working); inference config not working (e.g., the WTRU may indicate that an inference configuration associated with the functionality is not working); candidate CSI report config #1 is applicable (e.g., the WTRU may indicate and/or suggest that a first candidate CSI report configuration is applicable); candidate CSI report config #2 is applicable (e.g., the WTRU may indicate and/or suggest that a second candidate CSI report configuration is applicable); candidate inference config #1 is applicable (e.g., the WTRU may indicate and/or suggest that a first candidate inference configuration is applicable); and/or candidate inference config #2 is applicable (e.g., the WTRU may indicate and/or suggest that a second candidate inference configuration is applicable), etc.

After sending the signaling, for example based on the second CSI report configuration, on indicating the non-applicability of a functionality, the WTRU may receive a request and/or indication (e.g., from a gNB) to report the applicable functionalities (e.g., based on the WTRU's new conditions). The indication may include one or more indications to activate one or more applicable functionalities and one or more associated CSI report configurations. The indication may also include a flag indication indicating that the indication is in response to the reception of signaling from the WTRU on the non-applicability of one or more functionalities. The WTRU may verify, and if the WTRU determines that it sent an indication on non-applicability of a functionality, the WTRU may apply the indicated functionality and/or indicated CSI report configurations. As such, the WTRU may send one or more measured, evaluated, determined, and/or predicted parameters based on the indicated CSI report configurations.

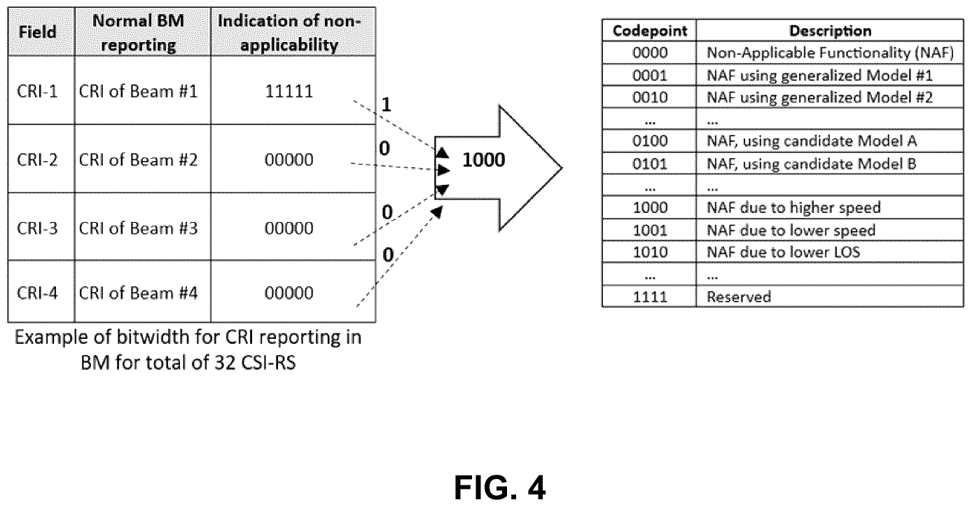

FIG. 4 illustrates an example of indicating codepoints via CRI signaling. A second CSI report configuration may be configured for indicating and/or signaling that one or more of the functionalities associated with a first associated CSI report configuration are non-applicable. The WTRU may also indicate if the WTRU is applying a new functionality and/or AIML model, where the new functionality and/or model number may be a (pre)configured and/or indicated generalized model, candidate model, etc. For example, the generalized model and/or functionality may be configured based on cell-common, group-common, cell-specific, and/or group-specific configurations. In another example, the candidate model and/or functionality may be configured based on group-common, group-specific, and/or WTRU-specific configurations. Additionally, the WTRU may use the second CSI report configuration to provide the reasons for the non-applicability. For example, the codepoints may indicate one or more of the following example indications, as shown in FIG. 4: Non-Applicable Functionality (NAF) (e.g., the WTRU may indicate the non-applicability of the associated functionality); NAF, using generalized Model (e.g., the WTRU may indicate that due to determining the NAF for the corresponding functionality, the WTRU may use and/or apply a determined, (pre)configured, and/or indicated generalized functionality and/or model (e.g., Model #1, Model #2, etc.)); NAF, using candidate Model (e.g., the WTRU may indicate that due to determining the NAF for the corresponding functionality, the WTRU may use and/or apply a determined, (pre)configured, and/or indicated candidate functionality and/or model (e.g., Model A, Model B, etc.); and/or NAF reasons (e.g., the WTRU may indicate the reasons based on which the NAF for the corresponding functionality may be determined and/or detected, where one of more of the following reasons may be indicated: due to speed changes, due to mobility changes, due to changes in the probability of LOS, etc.).

A second mode of operation may be performed, where the WTRU may drop, delay, and/or omit CSI reports. A WTRU may receive, determine, be configured, and/or indicated with configuration information and/or indications to operate based on a second mode of operation when determining that one or more functionalities are non-applicable. For example, the WTRU may receive the configuration information and/or indications via SIB, RRC, MAC-CE, DCI, etc.

The WTRU may be configured and/or indicated with one or more CSI report configurations, where the configured CSI report configurations may be associated with one or more functionalities. In an example, the second mode of operation may be based on dropping, delaying, and/or omitting the CSI reports associated with the non-applicable functionalities.

The WTRU may delay the CSI report in the second mode of operation. The WTRU may delay the CSI report transmission. For example, the WTRU may determine, be configured, and/or indicated with the delaying time duration to delay transmitting the CSI report. As such, the WTRU may initiate a timer after determining that at least a functionality is non-applicable, based on the configured delaying time duration. As such, the WTRU may delay transmitting the CSI report associated with the non-applicable functionalities until the corresponding timer elapses. After the timer elapses, the WTRU may check for the applicability of the functionality. If the corresponding functionality is now applicable, the WTRU may continue with the associated CSI reports. If the corresponding functionality is non-applicable, the WTRU may initiate a timer again. Alternatively, the WTRU may send one or more indications (e.g., to a gNB) (e.g., via UAI) indicating the non-applicability of the functionality. In an example, the WTRU may use a special SR, HARQ-ACK codebook, UCI, MAC-CE, RRC, etc., as described herein.

The time duration for delaying may be configured to be dependent on the level of non-applicability (e.g., if the WTRU is doing the determination of the non-applicability based on performance levels/accuracy). The WTRU may further be configured with several accuracy thresholds, and delay timer values corresponding with an (e.g., each) accuracy threshold (e.g., delay time duration=0 if accuracy is above 95%, delay time duration of t1 if accuracy is between 85% and 95%, delay time duration of t2 if accuracy is between 75% and 85%, and delay time duration=infinity (e.g., stop using this configuration/functionality) if accuracy is below 75%, etc.). Instead of specifying different delay time duration values corresponding to a (e.g., each) performance KPI level/threshold/range (e.g., as in the previous example), the WTRU may be configured with a baseline delay time duration (e.g., for a certain specific KPI level/threshold/range) and it may derive the delay time duration to use for other KPI levels/thresholds/ranges as a function of the baseline delay time duration value and a scaling factor (e.g., where the scaling factor is a relative ratio between the baseline KPI level and the current KPI level, etc.).

The WTRU may drop or omit the CSI report in the second mode of operation. The WTRU may drop and/or omit the CSI report transmission. For example, the WTRU may determine, be configured, and/or indicated with dropping the CSI report. The WTRU may send one or more indications (e.g., to a gNB) (e.g., via UAI) indicating the non-applicability of the functionality. In an example, the WTRU may use a special SR, HARQ-ACK codebook, UCI, MAC-CE, RRC, etc., as described herein. The WTRU may be configured to omit a certain number of CSI reports and then perform the applicability determination to see if the functionality is now applicable, and if so, stop the omitting. In another example, the number of CSI reports it omits may be configured to be dependent on the level of applicability of the functionality (e.g., if the applicability determination is based on performance level, similar to the other examples disclosed herein).

The WTRU may partially drop the CSI report in the second mode of operation. The WTRU may determine, be configured, and/or indicated with partially dropping of the CSI report. In an example, the WTRU may partially drop and/or omit the CSI report transmission. The WTRU may operate based on a hybrid of the first and second modes of operation, as described herein, where the first mode may be based on continuing in transmitting the CSI reports and the second mode may be based on dropping the CSI reports.

The WTRU may initiate a timer and/or determine to operate based on “partial dropping” for a determined, configured, and/or indicated time window. The WTRU may determine if the corresponding CSI report can be divided into separate parts. If the corresponding CSI report can be divided into more than one part, the WTRU may (e.g., only) transmit a first part and drop other parts. In this way, the WTRU may avoid overloading the system by transmitting multiple (e.g., all) parts of the inaccurate CSI with high overhead. Also, the WTRU may indicate the non-applicability of the reported CSI via sending indications in the transmitted first part. Alternatively, the WTRU may determine a high priority value for the first part of the corresponding CSI report (e.g., lowest priority), where the WTRU may report the indications on the non-applicability of the reported CSI, for example by reporting the determined CSI report priority level (e.g., via MAC-CE, UCI, RRC, etc.).

The WTRU may operate based on the “partial dropping” until the timer elapses, the determined time-window passes, and/or if the WTRU determines that the corresponding functionality is applicable again. If the timer elapses or the configured time-window passes and the functionality is still non-applicable, the WTRU may send one or more indications (e.g., to a gNB) (e.g., via UAI) indicating the non-applicability of the functionality. In an example, the WTRU may use a special SR, HARQ-ACK codebook, UCI, MAC-CE, RRC, etc., as described herein.

A WTRU may realize that due to changes in channel, the WTRU's speed, LOS, etc., the WTRU cannot perform the required CSI measurement and reporting (e.g., with regards to beam management). Upon determining the non-applicability of a first functionality, the WTRU may initiate a timer. The WTRU may continue to send (e.g., inaccurate) CSI reports while indicating the non-applicability to the gNB (e.g., via MAC-CE). If the non-applicability continues and the timer elapses, the WTRU indicates the non-applicability and a potential applicable candidate functionality to the gNB (e.g., via UE-assisted information (UAI).

Instead of immediate fallback to non-AIML operation, the WTRU may give some time for the gNB to indicate the WTRU's action. Based on the report, gNB may realize that the received CSI reports are not accurate enough. As such, the gNB may send an indication to the WTRU to fall back to non-AIML procedure or use a second (e.g., new) applicable functionality.

The WTRU may receive one or more sets of CSI report configurations (e.g., for beam management) based on WTRU-side AIML models, where the received sets of CSI report configurations may be associated with one or more (e.g., first) functionalities in AIML models.

The WTRU may consider a first functionality as applicable based on one or more conditions (e.g., the WTRU's speed, LOS, etc. being with configured ranges). If one or more of the conditions are out of the configured ranges, the WTRU may consider the first functionality as non-applicable.

If the functionality that is associated with a CSI report is determined to be non-applicable, the WTRU may initiate a timer based on a determined and/or (pre)configured time value.

The WTRU may determine the priority level for the non-applicable CSI reports equal to a (pre)configured and/or MAX value (e.g., lowest priority).

The WTRU may send the CSI reports including inaccurate (e.g., predicted) values. The WTRU may also send an (e.g., first) indication on non-applicability of the corresponding functionality (e.g., by indicating the determined priority value) for the reported CSI (e.g., via MAC-CE). For example, the WTRU may transmit an indication that the first functionality is non-applicable to the network.

The WTRU may continue transmitting the CSI report (e.g., in addition to the non-applicability indication) until the functionality is again applicable or until the timer elapses.

If the timer elapses, the WTRU may send an (e.g., second) indication (e.g., in UAI) (e.g., via RRC) on non-applicability of the corresponding functionality. The WTRU may send an indication suggesting a new applicable candidate functionality to the network (e.g., gNB).

The WTRU may receive indication(s) from the network (e.g., via RRC) to fallback to non-AIML operation, use a second applicable functionality, etc.

The WTRU may use the second applicable functionality to predict the best beams and report the beams based on the configured CSI report configurations.

1. A wireless transmit/receive unit (WTRU) comprising a processor configured to:
receive, from a network, a set of channel state information (CSI) report configurations, wherein the received set of CSI report configurations are associated with one or more functionalities associated with an artificial intelligence/machine learning (AIML) model;
determine, based on one or more conditions, that a first functionality of the one or more functionalities is non-applicable; and
start a timer based on determining that the first functionality is non-applicable;
transmit, to the network, a first indication that the first functionality is non-applicable
transmit, to the network, one or more CSI reports, wherein the one or more CSI reports comprise one or more predicted values;
determine that the timer has expired; and
transmit, based on determining that the timer has expired, a second indication that the first functionality is non-applicable.

2. The WTRU of claim 1, wherein the processor is further configured to receive, from the network, one or more of an indication to fallback to non-AIML operation or an indication to use an applicable second functionality of the one or more functionalities.

3. The WTRU of claim 2, wherein the processor is further configured to:
use the applicable second functionality to predict one or more best beams; and
report, to the network, the predicted one or more best beams using a CSI report configuration of the received set of CSI report configurations.

4. The WTRU of claim 1, wherein the one or more conditions comprise a change in one or more of a speed of the WTRU, one or more channels, or a loss of service.

5. The WTRU of claim 1, wherein the processor is further configured to determine a priority level associated with the one or more CSI reports based on the received set of CSI report configurations.

6. The WTRU of claim 5, wherein the first indication that the first functionality is non-applicable comprises an indication of the priority level.

7. The WTRU of claim 1, wherein the first indication that the first functionality is non-applicable is transmitted via MAC-CE.

8. The WTRU of claim 1, wherein the second indication that the first functionality is non-applicable is transmitted via RRC.

9. A method implemented in a wireless transmit/receive unit (WTRU), the method comprising:
receiving, from a network, a set of channel state information (CSI) report configurations, wherein the received set of CSI report configurations are associated with one or more functionalities associated with an artificial intelligence/machine learning (AIML) model;
determining, based on one or more conditions, that a first functionality of the one or more functionalities is non-applicable; and
starting a timer based on determining that the first functionality is non-applicable;
transmitting, to the network, a first indication that the first functionality is non-applicable
transmitting, to the network, one or more CSI reports, wherein the one or more CSI reports comprise one or more predicted values;
determining that the timer has expired; and
transmitting, based on determining that the timer has expired, a second indication that the first functionality is non-applicable.

10. The method of claim 9, further comprising receiving, from the network, one or more of an indication to fallback to non-AIML operation or an indication to use an applicable second functionality of the one or more functionalities.

11. The method of claim 10, further comprising:
using the applicable second functionality to predict one or more best beams; and
reporting, to the network, the predicted one or more best beams using a CSI report configuration of the received set of CSI report configurations.

12. The method of claim 9, wherein the one or more conditions comprise a change in one or more of a speed of the WTRU, one or more channels, or a loss of service.

13. The method of claim 9, further comprising determining a priority level associated with the one or more CSI reports based on the received set of CSI report configurations.

14. The method of claim 13, wherein the first indication that the first functionality is non-applicable comprises an indication of the priority level.

15. The method of claim 9, wherein the first indication that the first functionality is non-applicable is transmitted via MAC-CE.

16. The method of claim 9, wherein the second indication that the first functionality is non-applicable is transmitted via RRC.
